(19) United States
(12) Patent Application Publication
(10) Pub. No.: US 2025/0164829 A1
(43) Pub. Date: May 22, 2025

(54) A HYBRID SILICON PHOTONICS MODULATOR AND METHOD TO MANUFACTURE THE SAME

(71) Applicant: ADVANCED MICRO FOUNDRY PTE. LTD., Singapore (SG)

(72) Inventors: Shawn Yohanes SIEW, Singapore (SG); Xianshu LUO, Singapore (SG); Patrick Guo Qiang LO, Singapore (SG)

(73) Assignee: ADVANCED MICRO FOUNDRY PTE. LTD., Singapore (SG)

(21) Appl. No.: 18/833,564

(22) PCT Filed: Mar. 4, 2022
(86) PCT No.: PCT/SG2022/050115

§ 371 Date: Jul. 26, 2024

(51) Int. Cl. G02F 1/035

(52) U.S. Cl. CPC G02F 1/035; G02F 2202/20

(57) ABSTRACT

The present disclosure relates generally to a hybrid modulator and methods of integrating hybrid materials, such as lithium-niobate-on-insulator, onto silicon-on-insulator (SOI) wafers for hybrid silicon photonics integration, while maintaining compatibility with standard silicon photonics components. In particular, the silicon on insulator (SOI) and lithium-niobate-on-insulator (LNOI) are bonded together to allow the modulator to be compatible with lithium-niobate devices or silicon devices via a single transition layer.

### TECHNICAL FIELD

The present disclosure relates generally to a hybrid modulator and methods of integrating hybrid materials, such as lithium-niobate-on-insulator (LNOI), onto silicon-on-insulator (SOI) wafers.

### BACKGROUND

Silicon photonics provides a platform for forming silicon integrated circuits and semiconductor lasers. Silicon photonics assists in faster data transfer over long distances and facilitates CMOS-like fabrication thereby resulting in high-volume and low-cost production of Integrated Circuits. One major application of silicon photonics is high-speed data communications, such as optical interconnect in data centers. Additionally, silicon photonics finds application in sensing and high-performance computing.

An international PCT publication number PCT/SG2020/050253 discloses A hybrid photonic chip comprising a plurality of semiconductor materials arranged to define a chip providing a function, wherein at least a first part of the chip is formed of materials which can be fabricated using a CMOS technique; and at least a second part of the chip which comprises non-linear crystal material and is not subjected to etching process; wherein the second part of the chip in conjunction with the first part is configured to support a propagating low loss single mode. This prior art focuses on the waveguiding structure of the hybrid device, and is not compatible with the current silicon photonic devices, due to the bonding of the silicon and the lithium niobate. Further, this prior art mainly focuses on process integration and methods of making a modulator and not focus on the process integration with a standard silicon photonics component. In such modulator and its method, an addition of LNOI wafers may break compatibility. Thus, it is important to maintain compatibility with the current library of silicon photonics components, otherwise a whole new library of (Process Design Kit) PDK components are needed.

In another prior art, Title: A heterogeneously integrated silicon photonic/lithium niobate travelling wave electro-optic modulator, by Sandia National Laboratory, published in Optics Express, Vol. 28, Issue 2, pp. 1868-1884 (2020), a hybrid integrated silicon photonics modulators are disclosed. Silicon photonics is a platform that enables densely integrated photonic components and systems and integration with electronic circuits. Depletion mode modulators designed on this platform suffer from a fundamental frequency response limit due to the mobility of carriers in silicon. Lithium niobate-based modulators have demonstrated high performance, but the material is difficult to process and cannot be easily integrated with other photonic components and electronics. In this manuscript, the authors simultaneously take advantage of the benefits of silicon photonics and the Pockels effect in lithium niobate by heterogeneously integrating silicon photonic-integrated circuits with thin-film lithium niobate samples. It is demonstrated that the most CMOS-compatible thin-film lithium niobate modulator to date, which has electro-optic 3 dB bandwidths of 30.6 GHZ and half-wave voltages of 6.7 V×cm. These modulators are fabricated entirely in CMOS facilities, with the exception of the bonding of a thin-film lithium niobate sample post fabrication, and require no etching of lithium niobate. In this prior art, the method requires additional layers of SiN, that needs to go through multiple transitions from the silicon layer to reach the lithium niobate layer. As a result, experiences very high insertion loss of −10 dB.

In one another publication, Titled: High-performance hybrid silicon and lithium niobate Mach-Zehnder modulators for 100 Gbits-1 and beyond, by Sun Yat-sen University in Nature Photonics (2019). Optical modulators are at the heart of optical communication links. Ideally, they should feature low loss, low drive voltage, large bandwidth, high linearity, compact footprint and low manufacturing cost. Unfortunately, these criteria have been achieved only on separate occasions. Based on a silicon and lithium niobate hybrid integration platform, it is demonstrated that Mach-Zehnder modulators that simultaneously fulfil these criteria. The presented device exhibits an insertion loss of 2.5 dB, voltage-length product of 2.2 V cm in single-drive push-pull operation, high linearity, electro-optic bandwidth of at least 70 GHz and modulation rates up to 112 Gbit s⁻¹. The high-performance modulator is realized by seamless integration of a high-contrast waveguide based on lithium niobate a popular modulator material with compact, low-loss silicon circuitry. The hybrid platform demonstrated here allows for the combination of ‘best-in-breed’ active and passive components, opening up new avenues for future high-speed, energy-efficient and cost-effective optical communication networks. However, this method is not compatible with current silicon photonics library, as the (Lithium Nitrate) LN layer directly affects the optical mode of the silicon layer.

Hybrid integration with (Lithium Niobate-on-Insulator) LNOI are difficult to combine with standard silicon photonics (Silicon on Insulator) SOI wafers, while maintaining compatibility with standard silicon photonics components. As a result, for many types of hybrid LNOI-SOI, a new library of devices are required.

As such, there is a need to provide modulators with hybrid integration of materials, such as lithium-niobate-on-insulator, onto silicon-on-insulator (SOI) wafers that will maintain compatibility with standard SOI photonic devices.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

In a first aspect of the present disclosure, there is provided a hybrid silicon photonics modulator comprising: a first part comprising a first oxide layer, a first substrate layer and a waveguide, wherein the first oxide layer comprises one or more etched regions; a second part comprising a non-CMOS material layer and a second oxide layer; and at least two electrodes, wherein the first part is bonded to the second via the at least two electrodes and/or via the non-CMOS material layer, wherein the modulator is compatible with both lithium-niobate devices and silicon devices.

In one embodiment, the first part is the silicon on insulator (SOI) and is CMOS compatible, and the first oxide layer is the silicon dioxide (SiO₂) layer.

In one embodiment, the second part is a lithium-niobate-on-insulator (LNOI) and is non-CMOS compatible, the non-CMOS material layer is a lithium niobate layer and the second oxide layer is a silicon dioxide (SiO₂) layer.

In one embodiment, the waveguide is a silicon (Si) waveguide or silicon nitride (SiN) waveguide.

In one embodiment, the lithium niobate layer is positioned to be in contact with the waveguide.

In one embodiment, the lithium niobate layer is positioned adjacent to and above the waveguide.

In one embodiment, the electrodes are positioned below the lithium niobate layer.

In one embodiment, the electrodes are positioned above the lithium niobate layer.

In one embodiment, the SOI is bonded to the LNOI via the electrodes and the lithium niobate layer.

In one embodiment, the one or more etched regions comprise two gaps etched into the silicon dioxide (SiO₂) layer of the SOI, wherein the electrodes form metallic pillars that are lithographically positioned in the two gaps.

In one embodiment, the two gaps are separated by the waveguide positioned inbetween.

In one embodiment, the lithium niobate layer forms a metallic bond with the metallic pillars and wherein the metallic pillars are positioned below the lithium niobate layer.

In one embodiment, the metallic pillars are configured to operate as travelling wave electrodes and are positioned at any combination below, above, or at a level of the second part.

In one embodiment, the SOI is bonded to the LNOI via the lithium niobate layer.

In one embodiment, the lithium niobate layer is directly bonded on top of the waveguide, wherein the silicon dioxide (SiO₂) layer is positioned on top of the lithium niobate layer and the electrodes are positioned on top of the silicon dioxide (SiO₂) layer.

In one embodiment, the LNOI is enclosed within the SOI with only the top surface of the LNOI being exposed.

In one embodiment, the silicon device is a Multi-Project Wafer (MPW) semiconductor.

In one embodiment, the second part comprises one or more etched regions for bonding with the second part.

In a second aspect of the present disclosure, there is provided a lithium-niobate or silicon device integrated with the modulator via a single transition layer.

In a third aspect of the present disclosure, there is provided a method of manufacturing a hybrid silicon photonics modulator comprising steps of: forming a first part comprising a first oxide layer, a first substrate layer and a waveguide, wherein the first oxide layer comprises one or more etched regions; and forming a second part comprising a non-CMOS material layer and a second oxide layer, wherein the first part is bonded to the second part via at least two electrodes and/or via the non-CMOS material layer, wherein the modulator is compatible with both lithium-niobate devices and silicon devices.

In one embodiment, the first part is bonded to the second part via at least two electrodes within the one or more etched regions, wherein the first part is CMOS compatible and the second part is non-CMOS compatible.

In one embodiment, the first part is bonded to the second part via the non-CMOS material layer, wherein at least two electrodes are position on the top surface of the second oxide layer.

In one embodiment, the first part is a Silicon-On-Insulator (SOI) and the second part is a lithium-niobate-on-insulator (LNOI), wherein the non-CMOS material layer is a lithium niobate layer.

In a fourth aspect of the present disclosure, there is provided a computer readable storage medium having stored thereon, a computer readable description of a hybrid silicon photonics modulator that, when processed in a chip fabrication system, causes the chip fabrication system to execute the method disclosed herein.

### BRIEF DESCRIPTION OF THE DRAWINGS

FIG. 1A is a cross sectional view of a Silicon-On-Insulator (SOI), in accordance with an embodiment of the present invention.

FIG. 1B is a cross sectional view of a lithium-niobate-on-insulator (LNOI) integrated with a Silicon-On-Insulator (SOI), in accordance with an embodiment of the present invention.

FIG. 2A to 2G illustrate the example process of integrating a lithium-niobate-on-insulator (LNOI) with a Silicon-On-Insulator (SOI), in accordance with an embodiment of the present invention.

FIG. 3A is a cross sectional view of a Silicon-On-Insulator (SOI), in accordance with an alternative embodiment of the present invention.

FIG. 3B is a cross sectional view of a lithium-niobate-on-insulator (LNOI) integrated with a Silicon-On-Insulator (SOI), in accordance with an alternative embodiment of the present invention.

FIG. 4A to 4G illustrate the example process of integrating a lithium-niobate-on-insulator (LNOI) with a Silicon-On-Insulator (SOI), in accordance with an alternative embodiment of the present invention.

FIG. 5A is a cross sectional view of a hybrid silicon photonics modulator, a transition layer and silicon device as shown in FIG. 6, in accordance with an embodiment of the present invention.

FIG. 5B is a top-down view of a hybrid silicon photonics modulator of FIGS. 2 and 5 connected to the transition layer and silicon device.

FIG. 6A to 6E illustrate optical modes at various sections of the hybrid silicon photonics modulator, in accordance with an embodiment of the present invention.

FIG. 7 is a top-down view of a hybrid silicon photonics modulator of FIG. 2 with additional bonding religions.

FIG. 8 is a cross sectional view of a hybrid silicon photonics modulator of FIG. 4, a transition layer and silicon device, in accordance with an embodiment of the present invention.

FIG. 9 is a top-down view of a hybrid silicon photonics modulator of FIG. 4.

FIG. 10 illustrates a flow chart of an example process of manufacturing a hybrid silicon photonics modulator, in accordance with an embodiment of the present invention.

FIG. 11 illustrates a flow chart of an example process of integrating a lithium-niobate-on-insulator (LNOI) with a Silicon-On-Insulator (SOI), in accordance with an embodiment of the present invention.

FIG. 12 illustrates a flow chart of an example process of integrating a lithium-niobate-on-insulator (LNOI) with a Silicon-On-Insulator (SOI), in accordance with an alternative embodiment of the present invention.

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

### DETAILED DESCRIPTION OF ILLUSTRATIVE EMBODIMENTS

The particular configurations discussed in the following description are non-limiting examples that can be varied and are cited merely to illustrate at least one embodiment and are not intended to limit the scope thereof.

The present invention discloses a hybrid integrated silicon photonics modulator and a method of manufacture of the same. Conventionally, the integration of a silicon on insulator (SOI) with a lithium-niobate-on-insulator (LNOI) is difficult to achieve, while maintaining compatibility with standard silicon photonics components. The addition of LNOI to SOI may break compatibility, thus it is important to maintain compatibility with the current library of silicon photonics components, otherwise a whole new library of PDK components are needed. As a result, for many types of hybrid LNOI-SOI modulators, a new library of devices are required.

In this regard, the present invention disclosed herein relates generally to the provision of a modulator that is formed by bonding two wafers (a host and donor wafer) or parts together while maintaining compatibility with standard silicon photonics components. More particularly, as disclosed herein a host wafer (i.e. first part) that is complementary metal-oxide semiconductor (CMOS) compatible can be bonded with a donor wafer (i.e. second part) that is non-CMOS compatible, whereby the resulting modulator is compatible with standard silicon photonics components.

Accordingly, the hybrid integrated silicon photonics modulator disclosed herein provides a process of integrating any CMOS compatible wafer and non-CMOS compatible wafer (e.g. LNOI with SOI) to ensure compatibility with standard silicon photonics devices. The process of integration to achieve this compatibility considers electrode placement and bonding techniques of the two wafer parts. These host and donor wafers can be combined without modifying the CMOS flow.

The modulator disclosed herein can be compatible with lithium-niobate devices or silicon devices. Moreover, the modulator disclosed herein can be integrated with lithium-niobate devices or silicon devices via a single transition layer. Due to the single transition layer (e.g. Si→SiN), insertion loss of the modulator is reduced. In contrast, in other hybrid modulators multiple transitions and several additional waveguiding layers are needed, causing high insertion loss.

In one embodiment, the lithium-niobate devices or silicon devices can include standard MPW silicon photonics devices, or any other silicon photonic or silicon nitride devices.

In one embodiment, there is provided a hybrid silicon photonics modulator comprising at least two parts (a first part and a second part) and at least two electrodes.

In one embodiment, the first part can be a complementary metal-oxide semiconductor (CMOS) compatible host wafer, and the second part can be a non-complementary metal-oxide semiconductor (CMOS) donor wafer. The first part can be bonded to the second via the at least two electrodes and/or via a second substrate layer of the donor wafer to form the modulator that is compatible with standard silicon photonics components.

In one embodiment, the modulator can be compatible with lithium-niobate devices or silicon devices via a single transition layer.

The first part can comprise a first oxide layer, a first substrate layer and a waveguide, wherein the first oxide layer can comprise one or more etched regions, and wherein the first part can be CMOS compatible. The second part can comprise a non-CMOS material layer and a second oxide layer, wherein the second part can be non-CMOS compatible.

In one embodiment, the first part can be a silicon on insulator (SOI) wafer and the first oxide layer is a silicon dioxide (SiO₂) layer.

In one embodiment, the non-CMOS material layer of the second part can be a nonlinear crystal material (sometimes referred to as c material) such as lithium niobate. Generally, lithium niobate is not compatible with standard CMOS fabrication. Accordingly, in one embodiment, the second part can be a lithium-niobate-on-insulator (LNOI) wafer. The materials other than the lithium niobate that are not compatible with standard CMOS fabrication include but not limited to, III-IV materials such as Indium Phosphide or Gallium Arsenide and Nonlinear Crystal Materials such as lithium tantalate or Potassium Dideuterium.

In one embodiment, there is provided a hybrid silicon photonics modulator comprising a silicon on insulator (SOI) and a lithium-niobate-on-insulator (LNOI), wherein the SOI is bonded to the LNOI to ensure compatibility with lithium-niobate devices or silicon devices via a single transition layer.

The silicon on insulator (SOI) can represent the first part of the modulator. The silicon on insulator (SOI) can include one or more silicon dioxide (SiO₂) layers, a substrate layer and a waveguide. A silicon (Si) layer can be optionally included. The lithium-niobate-on-insulator (LNOI) can represent the second part of the modulator. The lithium-niobate-on-insulator (LNOI) can include a lithium niobate layer and a silicon dioxide (SiO₂) layer. A silicon (Si) layer can be optionally included.

In one embodiment, the waveguide can be a silicon (Si) waveguide or silicon nitride (SiN) waveguide.

Upon integration and bonding of the first and second parts (i.e. SOI and LNOI) the second substrate layer of the second part can be positioned to be in contact with the waveguide, or spaced with a thin layer between the second substrate layer and the waveguide. In one embodiment, the second substrate layer can be positioned adjacent to and above the waveguide.

To integrate the first and second parts, the top layer of the first part can include one or more etched regions to accommodate the second part such that the second part is enclosed within the first part with only the top surface of the second part being exposed.

In one embodiment, the one or more etched regions can comprise an etched region whereby the top layer of the first part is etched until the waveguide. This etched region can be appropriately sized and shaped to house and accommodate the second part.

In one embodiment, the one or more etched regions can comprise two gaps or spaces extending vertically down below the level of the waveguide. In one embodiment, the two gaps can extend vertically down until a Silicon layer of the first part. The two etched gaps can be separated from one another by the waveguide positioned in between. These two gaps can be appropriately sized and shaped to house and accommodate electrodes.

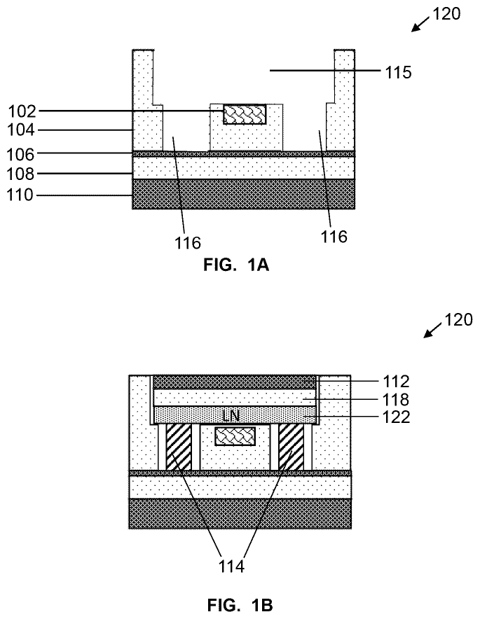

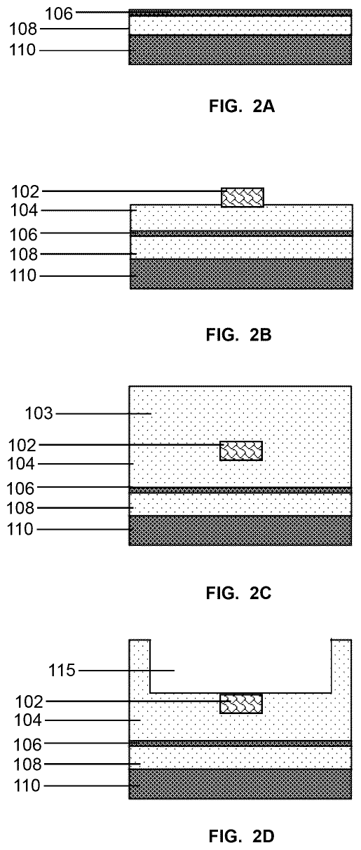

In order to explain the present invention, in FIGS. 1 to 12, the first part of the modulator is for example a SOI and the second part of the modulator is for example a LNOI. The present invention is not limited to SOI and LNOI, whereby any CMOS compatible host wafer and non-CMOS donor wafer can be bonded and integrated to form the modulator disclosed herein.

In the embodiments of the invention described below, the first part comprises one or more etched regions in a first oxide layer, a first substrate layer and a waveguide. FIG. 1A illustrates an embodiment showing the first part, for example, the silicon on insulator (SOI). A first part of the modulator, for example a SOI, comprises the first substrate layer 110, a first oxide layer, for example a first silicon dioxide layer 108, a silicon layer 106, an additional silicon dioxide layer 104 and a waveguide 102. The substrate layer 110 can form a bottom layer over which a buried oxide layer or first silicon dioxide layer 108 can be formed, subsequently the silicon layer 106 can be formed over layer 108 followed by the additional silicon dioxide layer 104 which forms a top layer of the SOI with an exposed surface. The waveguide 102 can be located within and surrounded by the additional silicon dioxide layer 104 in a central position. The waveguide can include an input and an output to a single transition layer.

The additional silicon dioxide layer 104 which forms a top layer of the SOI can comprise an etched region 115 and two etched gaps 116 that extend vertically down either side of the central waveguide. This results in a centrally positioned silicon dioxide section within which the waveguide 102 is located.

In the embodiments of the invention described below, second part having a second substrate layer and a second oxide layer. FIG. 1B illustrates an embodiment of the lithium-niobate-on-insulator (LNOI) integrated and bonded with the silicon on insulator (SOI) of FIG. 1A via two electrodes 114. A second part of the modulator, for example, LNOI comprises a lithium niobate layer 122, a second oxide layer, for example, a silicon dioxide (SiO₂) layer 118 and a second substrate layer, for example a silicon layer 112 that forms a top layer and surface of the LNOI. The two electrodes 114 can be connected to the bottom surface of said lithium niobate layer 122 and adjacent to opposite sides thereon. The silicon dioxide (SiO₂) layer 118 can be formed above the lithium niobate layer 122. In one embodiment, the lithium niobate layer 122 can form a metallic bond with the electrodes 114 that are positioned beneath the lithium niobate layer relative to the orientation of the LNOI when placed in the SOI. The first part of FIG. 1A is bonded to the second part of FIG. 1B via at least two electrodes 114,

During integration of the LNOI and SOI, each of the two electrodes 114, can be positioned and placed within one of the complementary etched gap 116 in the SOI. Accordingly, the two electrodes are positioned below the lithium niobate layer. The two electrodes 114 can be lithographically positioned in the two gaps. In one embodiment, the two electrodes 114 can be configured to operate as travelling wave electrodes. In one another embodiment of the invention the metallic pillars are configured to operate as travelling wave electrodes and are positioned at any combination below, above, or at a level of the second part.

Accordingly, in one embodiment, the SOI can be bonded to the LNOI via the two electrodes. These are bonded by metallic bonding or eutectic bonding, where the SOI and LNOI are patterned with an adhesive metal (such as titanium, platinum) and then with either eutectic materials or other metals (such as copper, aluminum). The metallic or eutectic bonding is used to bond these two wafers.

In one embodiment, the two electrodes 114 can be in the form of metallic pillars. This metallic material can be any metal fabricated in a commercial CMOS foundry, such as aluminum, copper, gold, etc, or any alloy of these metals.

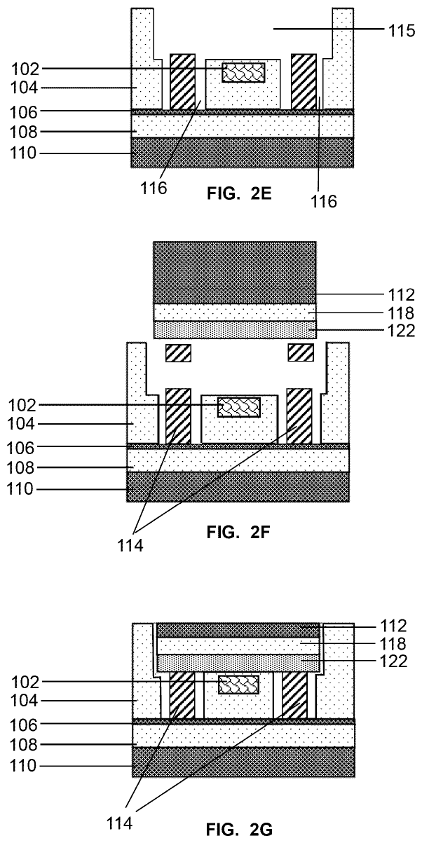

FIGS. 2A to 2G illustrate the example process of integrating a lithium-niobate-on-insulator (LNOI) with a Silicon-On-Insulator (SOI), in accordance with an embodiment of the present invention. Referring to FIG. 2A, the first part of the modulator is for example a SOI wafer. The SOI wafer has a substrate 110, silicon dioxide layer 108 and the silicon layer 106. As shown in FIG. 2B, the silicon dioxide layer 104 is grown, then a SiN layer 102 is grown and patterned to form the waveguide. Then, additional silicon dioxide (SiO₂) 103 is grown and planarized, as shown in FIG. 2C. Referring to FIG. 2D, an etched region 115 is defined, to provide a region for the bonding of the LNOI. The etched region 115 includes two etched gaps either side of the waveguide 102 to house the two electrodes, as shown in FIG. 2E. As shown in FIG. 2F, the LNOI can include two additional metal parts for bonding with the two complimentary electrodes such that the LNOI chip is bonded to the SOI wafer. Finally, as shown in FIG. 2F, the excess substrate on top of the LNOI may or may not be removed.

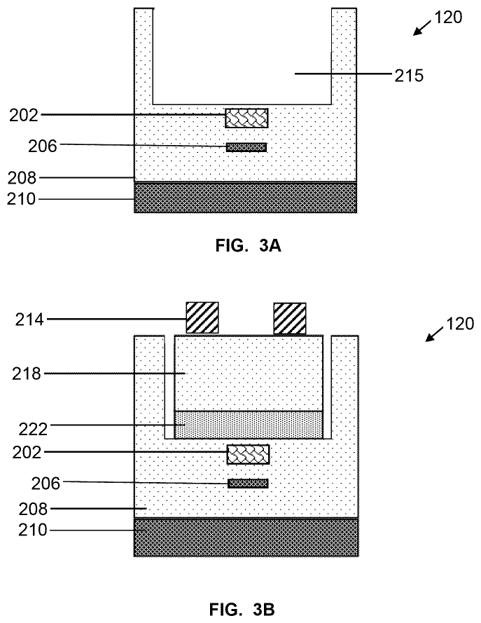

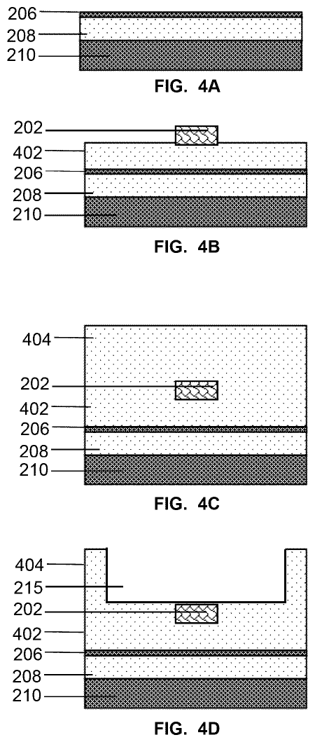

FIG. 3A illustrates another embodiment of the first part, for example, the silicon on insulator (SOI). The SOI or first part of the modulator can comprise the first substrate layer 210, the first oxide layer for example a silicon dioxide layer 208, the first substrate layer for example a silicon section 206 and the waveguide 202. The substrate layer can form a bottom layer over which the silicon dioxide layer 208 can be formed, subsequently the silicon section 206 can be formed with and surrounded by layer 208. The silicon dioxide layer 208 can form the top layer of the SOI with an exposed surface. The waveguide 202 can be located within and surrounded by the silicon dioxide layer 208 in a central position. The waveguide can include an input and an output to a single transition layer. It should be noted that the silicon section 206 (not part of the modulator) is compatible with a standard silicon photonics MPW process and can be used for coupling to a SiP circuit on a different part of the wafer/chip.

The silicon dioxide layer 208 which forms a top layer of the SOI can comprise an etched region 215 until the waveguide 202.

FIG. 3B illustrates another embodiment of the lithium-niobate-on-insulator (LNOI) integrated and bonded with the silicon on insulator (SOI) of FIG. 3A. The LNOI or second part of the modulator can comprise the non-CMOS material layer for example a lithium niobate layer 222, the second oxide layer for example a silicon dioxide (SiO₂) layer 218. In this embodiment, the two electrodes 214 can be coupled to the top surface of layer 218 and are positioned separate to each other adjacent to opposite sides of the top surface of layer 218. Accordingly, the two electrodes are positioned above the lithium niobate layer relative to the orientation of the LNOI when bonded with in the SOI. In this embodiment, the electrodes are not in contact with the lithium niobate layer 222. In particular, the silicon dioxide (SiO₂) layer 218 is formed between the lithium niobate layer 222 and the two electrodes 214.

In one embodiment, the SOI can be bonded to the LNOI via the lithium niobate layer 222. In one embodiment, the lithium niobate layer 222 can be directly bonded or fusion bonded to the SOI within the etched region 215. This direct bonding or fusion bonding can be enhanced with a deposition of a thin oxide layer, such as aluminum oxide.

Accordingly, the hybrid silicon photonics modulator disclosed herein can comprise a silicon on insulator (SOI) having one or more etched regions in a silicon dioxide (SiO₂) layer, wherein the SOI comprises a substrate layer and a waveguide; a lithium-niobate-on-insulator (LNOI) comprising a lithium niobate layer and a silicon dioxide (SiO₂) layer and at least two electrodes, wherein the SOI is bonded to the LNOI via the at least two electrodes and/or via the lithium niobate layer.

It should be noted that the two parts of the modulator, that is the first part and the second part can be termed as a host wafer and a donor wafer.

Advantageously, the modulator disclosed herein can be compatible with both lithium-niobate devices and silicon devices. In one embodiment, the silicon device can be a Multi-Project Wafer (MPW) semiconductor, or any other silicon photonics wafer, or silicon nitride wafer.

In one embodiment, a lithium-niobate device or silicon devices can be integrated or coupled to the modulator disclosed herein via a single transition layer.

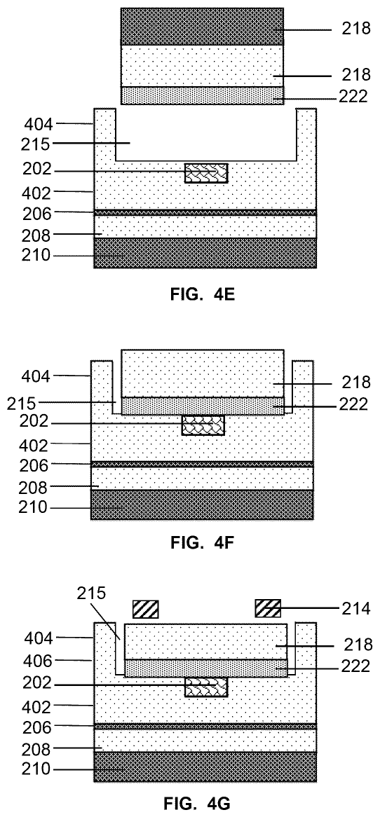

FIG. 4A to 4G illustrate the example process of integrating a lithium-niobate-on-insulator (LNOI) with a Silicon-On-Insulator (SOI), in accordance with an embodiment of the present invention. Referring to FIG. 4A, the first part of the modulator is for example a SOI. The SOI wafer has a substrate 210, silicon dioxide layer 208 and the silicon layer 206. As shown in FIG. 4B, the SiO₂ 402 is grown, then a SiN layer 202 is grown and patterned to form the waveguide. Then, additional silicon dioxide (SiO₂) 404 is grown, and then planarized, as shown in FIG. 4C. Referring to FIG. 4D, an etched region 215 is defined, to provide a region for the bonding of the LNOI. Then as in FIG. 4E, the LNOI is bonded within the etched region to the SOI. Then as shown in FIG. 4F, the substrate layer of the LNOI is removed. Finally, as shown in FIG. 4G, some of the silicon dioxide (SiO₂) may or may not be removed and then the two electrodes are bonded to the top surface of the LNOI.

In one embodiment, there is provided a method of manufacturing a modulator disclosed herein comprising steps of: forming one or more etched regions in a silicon dioxide (SiO₂) layer one of a Silicon-On-Insulator (SOI); forming a lithium-niobate-on-insulator (LNOI) comprising a lithium niobate layer and a silicon dioxide (SiO₂) layer, bonding together the LNOI and the SOI via at least two electrodes and/or via the lithium niobate layer.

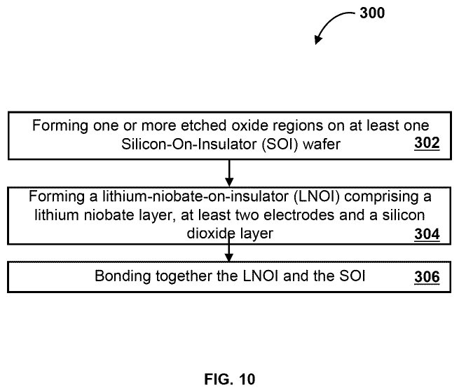

FIG. 10 illustrates a flow chart of an example process 300 of manufacturing a hybrid integrated silicon photonics modulator, in accordance with an embodiment of the present invention. As at step 302, one or more etched regions are formed in a silicon dioxide (SiO₂) layer of a Silicon-On-Insulator (SOI). Then, as at step 304, a lithium-niobate-on-insulator (LNOI) comprising a lithium niobate layer and a silicon dioxide (SiO₂2) layer is formed. Subsequently, at step 306, the LNOI and the SOI are bonded together via at least two electrodes and/or via the lithium niobate layer.

In step 306, the bonding of the LNOI to the SOI can include additional steps.

In one embodiment, the metallic pillars are lithographically placed into the etched region of the SOI and the lithium niobate layer is placed above the metallic pillars and waveguide of the SOI. The metallic pillars act as a metallic bond to the lithium niobate layer.

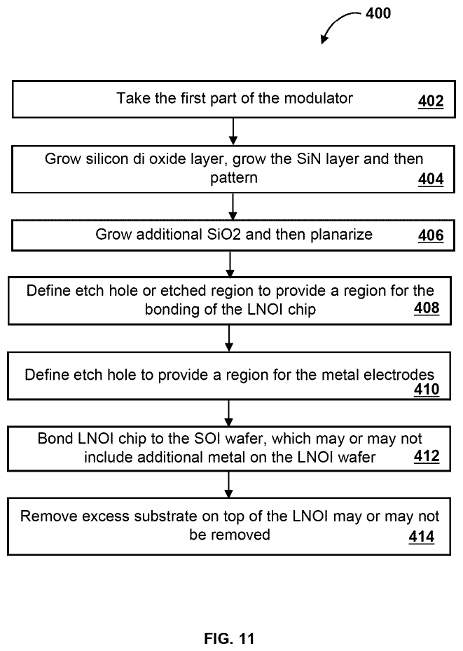

FIG. 11 illustrates a flow chart of an example process 400 of integrating a lithium-niobate-on-insulator (LNOI) with a Silicon-On-Insulator (SOI), in accordance with an embodiment of the present invention. Referring to step 402, the first part of the modulator, for example a SOI wafer is formed. The SOI wafer has a substrate, silicon dioxide layer and the silicon layer. As at step 404, the silicon dioxide layer is grown, then the SiN layer is grown and patterned. Then, as at step 406, some additional SiO₂ is grown, and then planarized. Referring to step 408, an etched region is defined, to provide a region for the bonding of the LNOI. Then as at step 410, etched gaps are defined, to provide a region for the each of the two electrodes. Additional regions can be defined to increase the total bonding strength. Then as at step 412, the LNOI is bonded to the SOI, which may or may not include additional metal on the LNOI wafer. Finally, as at step 414, the excess substrate on top of the LNOI may or may not be removed.

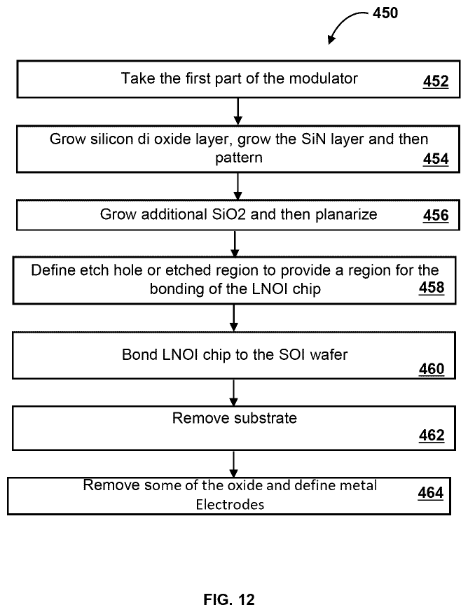

FIG. 12 illustrates a flow chart of an example process 450 of integrating a lithium-niobate-on-insulator (LNOI) with a Silicon-On-Insulator (SOI), in accordance with an alternative embodiment of the present invention.

As at step 452, the first part of the modulator is for example a SOI is taken. As shown at step 454, the SiO₂ is grown, then SiN is grown and patterned. Then, some additional SiO₂ is grown, and planarized, as shown at step 456. As at step 458, an etched region is defined, to provide a region for the bonding of the LNOI. Then as at step 460, the LNOI chip is bonded to the SOI within the etched region. Then at step 462 the excess substrate in the LNOI is removed.

Finally, as at step 464, some of the silicon dioxide may or may not be removed and then the two electrodes can be bonded to the top surface of the LNOI. In this regard, the lithium niobate layer can be directly bonded to the SOI within the etched region and positioned adjacent to the waveguide of the SOI. The electrodes are positioned on the top surface of the LNOI.

For integrating the modulator disclosed herein with a lithium-niobate device or silicon device, the method can comprise the additional steps of forming a transition layer and at least one silicon device, respectively.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

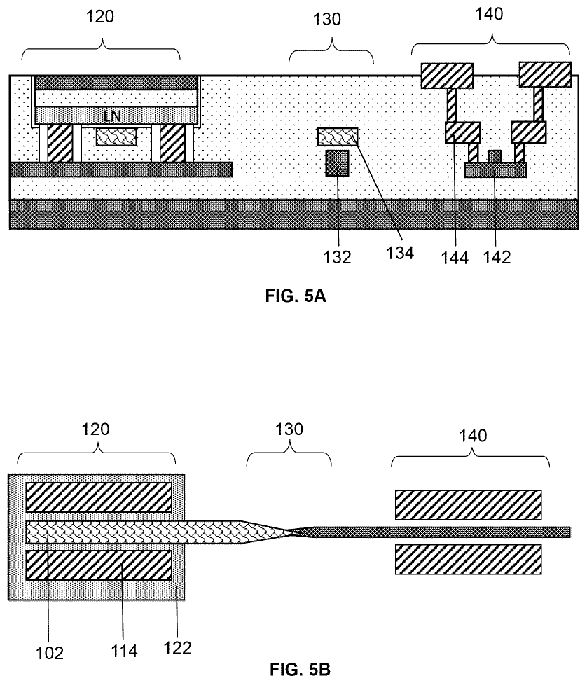

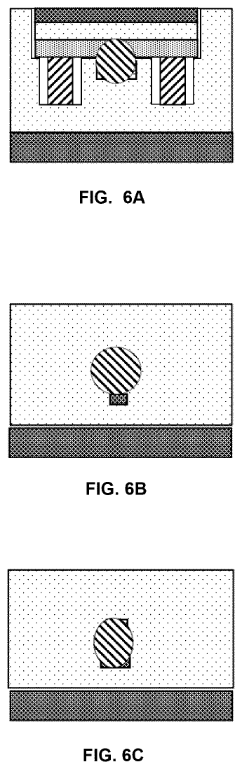

FIGS. 5A and 5B illustrate the connection of the modulator 120, as shown in the FIG. 2, to a silicon device 140 via a transition layer 130 in a wafer. The transition layer 130 allows the present invention to be compatible with other standard silicon photonics devices.

The transition layer 130 can be formed between the modulator 120 and the silicon device 140 and can comprise a silicon layer 132 and a silicon mono nitrate layer 134.

The silicon device 140 can comprise at least one silicon layer 142 and at least one metallic connector 144. In one embodiment, the silicon device 140 can acts as a Multi-Project Wafer (MPW) semiconductor. Thus, the modulator disclosed herein can be compatible with a standard ‘Multi-Purpose Wafer’ (MPW) flow, and is therefore compatible with a standard library of silicon devices.

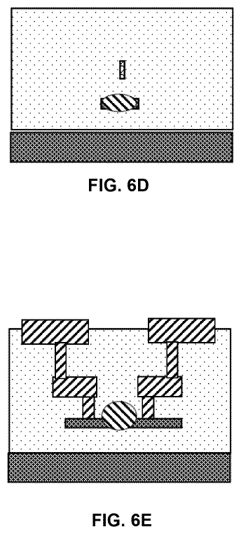

FIGS. 6A to 6E illustrate optical modes at various sections of the hybrid silicon photonics modulator, in accordance with an embodiment of the present invention. FIG. 6A shows the optical mode inside the top waveguide/LN section.

As shown in FIG. 6B, the optical mode inside the top waveguide section is adiabatically tapering smaller and at the same time, bottom waveguide (silicon or SiN) is adiabatically tapering larger.

Referring to FIG. 6C, the optical mode is supported in both top and bottom waveguide, slowly transferring to the bottom waveguide. FIG. 6D shows the optical mode fully in the bottom waveguide. Finally, FIG. 6E shows the bottom waveguide that is compatible with silicon photonics.

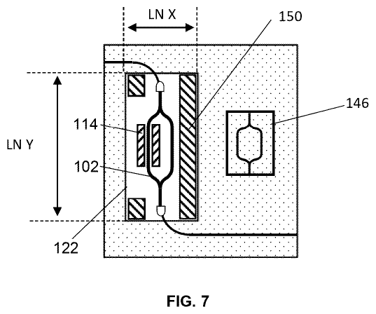

FIG. 7 shows a top-down view of the modulator of FIG. 2 defining a LN area that is integrated with a silicon area comprising a Silicon element or device 146 using transition sections. The waveguide 102, the metallic pillars 114 and the lithium niobate layer 122 of the modulator are visible in this view. In one embodiment, the modulator can include additional bonding religions 150. This configuration of components allows compatibility with standard SOI photonic process. The additional bonding religions 150 increases total bonding strength of the modulator.

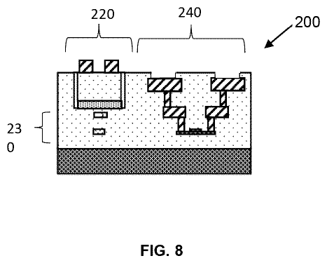

FIG. 8 illustrates the connection of the modulator 220, as shown in the FIG. 4, to a silicon device 240 via a transition layer 230 in a wafer.

The transition layer 230 can be formed between the modulator 220 and the silicon device 240 and can comprise a silicon layer 232 and a silicon mono nitrate layer 234. In one embodiment, the transition layer can be included in the modulator whereby the output of the waveguide of the modulator to the transition layer begins within the modulator.

The silicon device 240 can comprise at least one silicon layer and at least one metallic connector. In one embodiment, the silicon device 240 can act as a Multi-Project Wafer (MPW) semiconductor. Thus, the modulator disclosed herein can be compatible with a standard ‘Multi-Purpose Wafer’ (MPW) flow and is therefore compatible with a standard library of silicon devices.

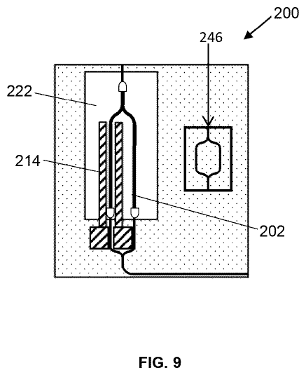

FIG. 9 shows a top-down view of the modulator of FIG. 4 defining an LN area that is integrated with a silicon area comprising a Silicon element or device 246 using transition sections. The waveguide 202, the electrodes 214 and the lithium niobate layer 2222 of the modulator are visible in this view. This configuration of components allows compatibility with standard SOI photonic process.

As the hybrid modulator comprises both the lithium-niobate device and silicon devices, the modulator is compatible with both the lithium-niobate device and the silicon device. It should be noted that in present invention there are two main locations for the metal electrodes (bottom metal/top metal) and two main types of waveguides (Si-LN/SiN-LN), which can be combined in any order without limitation.

The present invention provides a modulator with hybrid integration, in particular to ensure compatibility with standard silicon photonics devices. The disclosure herein includes unique electrode placement, bonding and process integration. As the modulator and fabrication method disclosed herein allows compatibility with a standard silicon photonic process, it can utilize both silicon photonics and LNOI type devices, and combine the advantages of each platform. In particular, optical modulation can be performed with the LNOI section, which can provide higher electro-optical bandwidth. However, the light can be coupled in via the SOI section, where high performance coupling structures (such as edge couplers and grating couplers) have been demonstrated. Secondly, the nonlinear effect of lithium niobate can be utilized, such as second harmonic generation and spontaneous parametric down conversion, to create a set of quantum devices that cannot be done in silicon. Thus, both the benefits of silicon and lithium niobate can be combined into a single photonic die. This particular invention need not to be limited to silicon and lithium niobate, any particular CMOS compatible wafer, and non-CMOS compatible wafer can be combined as such.

Using present invention hybrid silicon photonics integration is possible using integrating hybrid materials, such as lithium-niobate-on-insulator, onto silicon-on-insulator (SOI) wafers. Further the present invention is CMOS compatible and maintain compatibility with standard SOI photonic devices.

In addition to the foregoing, there is also provided a process design kit for forming a hybrid silicon photonics modulator disclosed herein which when processed in a fabrication system causes the fabrication system to from the modulator of any embodiment.

In one embodiment, there is provided a process design kit for forming a hybrid silicon photonics modulator disclosed herein, comprising: parameters to form a silicon on insulator (SOI) wafer having one or more etched regions in a silicon dioxide (SiO₂) layer, wherein the wafer comprises a substrate layer and a waveguide; parameters to form a lithium-niobate-on-insulator (LNOI) comprising a lithium niobate layer and a silicon dioxide (SiO₂) layer, parameters to bond the LNOI to the SOI via at least two electrodes and/or via the lithium niobate layer.

There may be provided a method of manufacturing, a process design kit as described herein. Furthermore, there may be provided process design kit dataset that, when processed in a fabrication system, causes the method of manufacturing a PIC and/or asymmetric alignment arrangement as described herein.

Additionally, there is also provided a computer readable storage medium having stored thereon a computer readable description of a modulator that, when processed in a fabrication system, causes the fabrication system to manufacture a modulator of any embodiment by executing the method disclosed herein.

Any range or device value given herein may be extended or altered without losing the effect sought, as will be apparent to the skilled person. It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed in a process design kit configures the system to manufacture some or all of the devices herein.

It will be appreciated that variations of the above disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

Although embodiments of the current disclosure have been described comprehensively in considerable detail to cover the possible aspects, those skilled in the art would recognize that other versions of the disclosure are also possible.

1. A hybrid silicon photonics modulator comprising:
a first part comprising a first substrate layer, a first oxide layer, and a waveguide, wherein the first oxide layer comprises one or more etched regions;
a second part comprising a second substrate layer, a second oxide layer and a non-CMOS material layer, wherein the non-CMOS material layer comprises one of a lithium niobate layer, a Ill-IV material, and a nonlinear crystal material; and
at least two electrodes,
wherein the non-CMOS material layer is bonded to the second oxide layer directly and to the at least two electrodes directly, and also physically separated from the first oxide layer by the at least two electrodes, or the non-CMOS material layer is bonded to the second oxide layer directly and to the first part directly, and also separated from the at least two electrodes by the second oxide layer.

2. The modulator of claim 1, wherein the first part is a silicon on insulator (SOI), and the first oxide layer is a silicon dioxide (SiO₂) layer.

3. The modulator of claim 1, wherein the second part is a lithium-niobate-on-insulator (LNOI) and is the second oxide layer is a silicon dioxide (SiO₂) layer.

4. The modulator of claim 1, wherein the waveguide is a silicon (Si) waveguide or silicon nitride (SiN) waveguide.

5. The modulator of claim 1, wherein non-CMOS material is the lithium niobate layer, and the lithium niobate layer is in contact with the waveguide.

6. The modulator of claim 5, wherein the lithium niobate layer is above the waveguide.

7. The modulator of claim 1, wherein the non-CMOS material layer is bonded to the second oxide layer directly, and to the at least two electrodes directly, and also physically separated from the first oxide layer by the at least two electrodes.

8. The modulator of claim 1, wherein the non-CMOS material layer is bonded to the second oxide layer directly, and to the first part directly, and also separated from the at least two electrodes by the second oxide layer.

9. (canceled)

10. The modulator of claim 2, wherein the one or more etched regions comprise two gaps etched into the silicon dioxide (SiO2) layer of the SOI, wherein the electrodes form metallic pillars that are lithographically positioned in the two gaps.

11. The modulator of claim 10, wherein the two gaps are separated by the waveguide positioned inbetween.

12.-15. (canceled)

16. The modulator of claim 2, wherein the non-CMOS material layer is enclosed within the silicon on insulator SOI.

17. (canceled)

18. The modulator of claim 1, wherein the modulator is operatively connected to a silicon device to form a Multi-Project Wafer (MPW) semiconductor.

19. The modulator of claim 1, wherein the first part comprises one or more etched regions for bonding with the second part.

20. A lithium-niobate or silicon device integrated with the modulator of claim 1 via a single transition layer.

21. A method for manufacturing a hybrid silicon photonics modulator comprising one or more steps of:
forming a first part comprising a first substrate layer, a first oxide layer, and a waveguide, wherein the first oxide layer comprises one or more etched regions;
forming a second part comprising a second substrate layer, a second oxide layer and a non-CMOS material layer, wherein the non-CMOS material layer comprises one of a lithium niobate layer, a Ill-IV material, and a nonlinear crystal material; and,
forming at least two electrodes;
wherein the non-CMOS material layer is bonded to the second oxide layer directly, and to the at least two electrodes directly, and also physically separated from the first oxide layer by the at least two electrodes, or the non-CMOS material layer is bonded to the second oxide layer directly, and to the first part directly, and also separated from the at least two electrodes by the second oxide layer.

22. The method of claim 21, wherein the non-CMOS material layer is bonded to the second oxide layer directly, and to the at least two electrodes directly, and also physically separated from the first oxide layer by the at least two electrodes.

23. The method of claim 21, wherein the non-CMOS material layer is bonded to the second oxide layer directly, and to the first part directly, and also separated from the at least two electrodes by the second oxide layer.

24. The method of claim 21, wherein the first part is a Silicon-On-Insulator (SOI) and the second part is a lithium-niobate-on-insulator (LNOI), wherein the non-CMOS material layer is the lithium niobate layer.

25. A computer readable storage medium having stored thereon, a computer readable description of the hybrid silicon photonics modulator that, when processed in a chip fabrication system, causes the chip fabrication system to execute the method of claim 21.
